(19) United States
(12) Patent Application Publication
(10) Pub. No.: US 2006/0164532 A1
(43) Pub. Date: Jul. 27, 2006

(54) Solid state imaging apparatus and driving method for the solid stateimaging apparatus

(75) Inventor: Katsumi Ikeda, Kurokawa-gun (JP)

Correspondence Address: BIRCH STEWART KOLASCH & BIRCH, PO BOX 747, FALLS CHURCH, VA, 22040-0747, US

(73) Assignee: FUJI PHOTO FILM CO. LTD

(21) Appl. No.: 11/288,305

(22) Filed: Nov. 29, 2005

(30) Foreign Application Priority Data
Nov. 30, 2004 (JP) 2004-346627

(51) Int. Cl. H04N 5/335

(52) U.S. Cl. 348/311

(57) ABSTRACT

A solid-state imaging apparatus comprises a semiconductor substrate that defines a two-dimensional surface; a plurality of photoelectric conversion elements, each of which generates a signal electric charge corresponding to an amount of incident light, the photoelectric conversion elements arranged in two-dimension on the semiconductor substrate; vertical signal charge transfer devices that are arranged between columns of the photoelectric conversion elements and transfer the signal electric charges generated by the photoelectric conversion elements in a vertical direction; a line memory that is arranged on ends of the vertical signal charge transfer devices and temporally stores the signal electric charges transferred by the vertical signal charge transfer devices; and a horizontal signal charge transfer devices that is consisted of four-phase electrodes, selectively reads the signal electric charges stored in the line memory, adds a plurality of the electric signal charges in a row direction and sequentially transfers the added electric signal charges.

### CROSS REFERENCE TO RELATED APPLICATION

This application is based on Japanese Patent Application 2004-346627, filed on Nov. 30, 2004, the entire contents of which are incorporated herein by reference.

### BACKGROUND OF THE INVENTION

A) Field of the Invention

This invention relates to a solid state imaging apparatus, and more in detail, relates to a driving method for the solid state imaging apparatus.

B) Description of the Related Art

FIG. 4A is a schematic plan view showing a structure of a conventional solid state imaging apparatus 10. FIG. 4B is a block diagram showing structures of photoelectric conversion elements 11, VCCD 12, reading parts 3g and line memories 13.

FIG. 5 is a driving timing chart of the solid state imaging apparatus 10 at a time of reading all pixels.

The solid state imaging apparatus 10 is consisted of a multiplicity of the photoelectric conversion elements (photodiodes) 11 arranged in two-dimension, plurality columns of the vertical electric charge transfer device (vertical charge coupled device: VCCD) 12 vertically transferring electric charges generated by the photoelectric conversion elements 11, the line memories (LM) 13, each of which is arranged on a downstream edge of each column of the VCCD 12 and temporally accumulates the signal electric charges transferred by the VCCD 12, a horizontal electric charge transferring device (horizontal charge coupled device: HCCD) 14 that horizontally transfers the signal electric charges temporally accumulated in the line memories 13 and an output amplifier 15. The VCCD 12 and the HCCD 14 are consisted by a charge-coupled device (CCD).

For example, driving waveforms φV1 to φV4 in the timing chart shown in FIG. 5 are imposed respectively on V1 to V4 electrodes of the VCCD 12. The driving waveforms φV1 to φV4 are well-known four-phase driving waveforms, and the signal electric charges accumulated in the photoelectric conversion elements 11 corresponding to the amount of irradiated light to the solid state imaging apparatus 10 are read out to the VCCD 12 via the reading unit 3g by imposing VH pulses φV1 and φV3 between Timing t1 and Timing t2 shown in FIG. 5.

The signal electric charges are sequentially transferred to a direction of the line memory 13 (lower side in the drawing) by alternatively imposing mid-level (VM) pulse and low-level (VL) pulse on the V1 to V4 electrodes of the VCCD 12 during a transferring period after Timing t2. The line memory 13 temporally accumulates the signal electric charges transferred from the VCCD 12. Thereafter by making φHn a HH level when the line memory 13 becomes LML level at Timing t3, the signal electric charges accumulated in the line memory 13 are selectively transferred to the HCCD 14.

The HCCD 14 sequentially transfers the signal electric charges horizontally to a direction of the output amplifier 15 by a well-known two-phase driving method. The output amplifier 15 detects the transferred signal electric charges, and output voltages corresponding to the amount of the irradiated lights are generated as the output signal (OS) waveform.

By the above-described basic operation, the solid-state imaging apparatus 10 is used as an image scanning apparatus having positional information of each of the photoelectric conversion elements 11 as the irradiated light being surface information. In order to recognize an image, the signal electric charge generated in each of the photoelectric conversion element 11 must be transferred without mixing with other signal electric charges or without eliminating a part of the signal electric charges, and voltage corresponding to the signal electric charge must be output.

FIG. 6A to FIG. 6G are diagrams for explaining movement of signal electric charges at Timing t1 to Timing t7 shown in FIG. 5. FIG. 6A to FIG. 6G are corresponding to Timing t1 to Timing t7 shown in FIG. 5 respectively.

Since the HCCD 14 has at least one electrode corresponding to one column of the VCCD 12, it can read out the signal electric charges from the VCCD 12 via the line memories 13 by every two columns. After transferring all of the signal electric charges read out by every two columns to the horizontal direction, the signal electric charges in the remaining columns stored in the line memories 13 are read out, and transfer of the signal electric charges corresponding to one line of the photoelectric conversion elements 11 will be finished by transferring the signal electric charges to the horizontal direction.

Moreover, in the example shown in FIG. 6A to FIG. 6G, color filters for obtaining color signals are formed above the photoelectric conversion elements 11 in a general G-striped arrangement in which green (G) filters are arranged in a tetragonal matrix, red (R) and blue (B) filters are arranged in a slanted checked pattern.

FIG. 6A shows a condition that the signal electric charge is accumulated in each photoelectric conversion element 11 at Timing t1. At Timing t2 after Timing t1, the signal electric charge is read out from the each photoelectric conversion element 11 to an adjacent VCCD 12 by imposing VH pulse to φV1 and φV3. Thereafter the condition will be that shown in FIG. 6B.

After that, the signal electric charges are transferred in the VCCD 12 in a vertical direction until Timing t3 as shown in FIG. 6C. At this time, the signal electric charges for one line are temporally stored in the line memories 13.

At Timing t4, the signal electric charges (R signal and B signal) are read out to the HCCD 14 by every two columns as shown in FIG. 6D. Then, at Timing t5, the signal electric charges (R signal and B signal) in the HCCD 14 are transferred in the horizontal direction as shown in FIG. 6E. After transferring all the signal electric charges in the HCCD 14, at Timing t6, the remaining signal electric charges (G signal) are read out from the line memories 13 to the HCCD 14 as shown in FIG. 6F. Thereafter, at Timing t7, the signal electric charges (G signal) in the HCCD 14 are transferred to the horizontal direction as shown in FIG. 6G. When all the remaining signal electric charges (G signal) in the HCCD 14 are transferred to the output amplifier 15, transfer of the signal electric charges for one column is finished.

It became necessary to shorten a time for updating one screen for a monitor output of a large-numbered pixel digital still camera in recent years, and a horizontal pixel addition is well known for a method of finishing reading-out a signal at high speed.

FIG. 7 is a driving timing chart of the solid-state imaging apparatus 10 at a time of the horizontal pixel addition, and FIG. 8A to FIG. 8E are diagrams for explaining changes in the signal electric charges at Timing t1 to Timing t5 shown in FIG. 7. FIG. 8A to FIG. 8E are respectively corresponding to Timing t1 to Timing t5 shown in FIG. 7.

The horizontal pixel addition shown in FIG. 7 and FIG. 8 differs from the reading out of all pixels shown in FIG. 5 and FIG. 6 in the timings after Timing t4. At the time of reading out all pixels, timing of the HCCD 14 is controlled by the two-phase driving; however, timing of the HCCD 14 is controlled by eight-phase driving to execute addition of the same colored signal electric charges by every eight pixels in the horizontal direction.

The signal electric charges are added by a combination shown in FIG. 8D by the above-described horizontal pixel addition. Moreover, arrows in the drawing indicate the combination of the signals, and transfers to reverse directions are not actually executed. The two-pixel horizontally added signal charges are sequentially transferred to the horizontal direction as shown in FIG. 8E.

By the above-described transferring operation, the fast added read-out that can increase horizontal resolution without decreasing sensitivity is performed.

A structure and a partial movement of the HCCD 14 for executing the horizontal pixel addition will be explained in the below.

FIG. 9 is a plan view showing electrode structures of the HCCD 14 and a vicinity of the line memories 13 including the VCCD 12. Moreover, since the photoelectric conversion elements 11 and the reading units 3g used in the solid-state imaging apparatus 10 are common; therefore, the explanations for those parts will be omitted.

The VCCD 12 has a four-phase (φV1 to φV4) driving structure. Odd-numbered electrodes (V1 and V3) are consisted of the second layer poly-silicon electrodes 8, and even-numbered electrodes (V2 and V4) are consisted of the first poly-silicon electrodes 9.

The electrode of each line memory 13 is consisted of one that the first layer poly-silicon electrode 9 and the second layer poly-silicon electrode 8 are electrically connected. Moreover, if the electrode of the line memory 13 is consisted of just one electrode, it does not affect the operation of the line memory 13.

The HCCD 14 is consisted of the eight-phase (φH1 to φH8) driving for executing the above-described adding operation; however, transfer may be executed by the well-known two-phase driving method if adding operation is not executed. In order to execute the well-known two-phase driving, the electrode 6 and the electrode 7 are electrically connected to make them one electrode.

FIG. 10 includes a diagram DIA. 10A showing a schematic cross sectional view showing the structure of the part shown in FIG. 9A to FIG. 9B.

A p-type impurity doped region (p-well) 2 is formed on an n-type semiconductor substrate 1. An n-type impurity layer 3 and an n-type impurity layer 4 are formed on a surface of the substrate. An electrode 6 under the line memory 13 and the HCCD 12 is formed on an insulating film 5 over the n-type impurity layer 3. An electrode 7 under the line memory 13 and the HCCD 12 is formed on the insulating film 5 over the n-type impurity layer 4. Moreover, the n-type impurity layer 4 has relatively lower impurity concentration than the n-type impurity layer 3.

Moreover, the VCCD 12 is consisted of the transfer electrodes 8 and 9 and a vertical transfer channel 3v formed beneath the insulating film 5 under the transfer electrodes 8 and 9.

In FIG. 10, diagrams DIA. 10B to DIA. 10G show electric potential of the part shown in diagram DIA. 10A. DIA. 10B is a condition at Timing t2 shown in FIG. 7 and FIG. 8, and DIA. 10C is a condition at Timing t3 shown in FIG. 7 and FIG. 8. Moreover, DIA. 10D to DIA. 10G are conditions at Timing t4 to Timing t5 shown in FIG. 7 and FIG. 8 wherein the signal electric charges are read out from the line memories 13 to the HCCD 14 and are transferred. Moreover, “H” in the drawing indicates electric potential when “HH” in a case of the HCCD 14, “LMH” in a case of the line memory 13 or “VM” in a case of the VCCD 12 shown in the timing chart shown in FIG. 7 is imposed. Further, “L” in the drawing indicates electric potential when “HL” in a case of the HCCD 14, “LML” in a case of the line memory 13 or “VL” in a case of the VCCD 12 shown in the timing chart shown in FIG. 7 is imposed.

As shown in diagrams DIA. 10B and DIA. 10C, an electric potential barrier toward the line memory 13 is eliminated by imposing VM to φV4, and therefore the signal electric charge will be moved to the line memory 13.

Next, as shown in diagrams DIA. 10D and DIA. 10E, the signal electric charge are read out from the line memory 13 to the HCCD 14 by imposing “HH” to the HCCD 14 (φH1 in a case of the example shown in the drawing) and imposing “LML” to the line memory 13 (φLM).

Then, as shown in diagrams DIA. 10F and DIA. 10G, the signal electric charge is transferred in a horizontal direction by imposing “HL” to the electrode (φH1 in a case of the example shown in the drawing) where the signal electric charge of the HCCD 14 is stored and imposing “HH” to the electrode (φH8 in a case of the example shown in the drawing) that is next to the electrode storing the signal electric charge of the HCCD 14.

FIG. 11 is a table representing a relationship between the electric potential and the movement of the signal electric charge. This table indicates whether the signal electric charge moves or not in the condition when voltage is imposed on the electrode over the n-type impurity layer 4 storing the signal electric charge and the electrode on the downstream. Moreover, the case that the same voltage is imposed on the line memory 13 (φLM) and on the HCCD 14 (φH) in the drawing.

Obviously from the drawing, the signal electric charge moves only when the electrode over the n-type impurity layer 4 storing the signal electric charge is “L” and the electrode on the downstream is “H”.

FIG. 12 is a timing chart when the horizontal pixel addition is executed by the eight-phase driving method by the HCCD 14 and a diagram showing movement of the signal electric charges. In the drawings, the timing chart on the left side represents driving waveform of the line memory 13 and the HCCD 14, and a simple plan view on the right side represents the movement of the signal electric charges corresponding to the timing chart. In this plan view, an upper small square indicates the electrode (LM) of the line memory 13, and a lower large squire indicates the electrodes (H1 to H8) of the HCCD 14. Moreover, the parts marked with “R”, “G” and “B” indicate colors of the signal electric charges accumulated under each electrode, and the signal electric charges are accumulated where “R”, “G” and “B” are marked.

Timing t1 is a condition that the signal electric charges transferred from the VCCD 12 are accumulated in the line memories 13. After that, at Timing t2, “HH” is imposed to the H5 electrodes. Then at Timing t3, every one of two R signals in a horizontal direction is read out to the HCCD 14 by imposing “LML” on LM electrodes.

At Timing t4 to Timing t8, “HL” is imposed to the electrodes under which the signal electric charges are accumulated, and “HH” is sequentially imposed to the electrodes on the downstream. Then, the R signals read out to the HCCD 14 are sequentially transferred to downstream in the horizontal direction to be positioned on the downstream of the same colored signals remaining in the line memories 13 in a vertical direction.

Next, at Timing t9, “HH” is imposed to H4, H7 and H8 electrodes, and every one of two horizontally adjacent G signals and every one of two horizontally adjacent B signals are read out to the HCCD 14 by imposing “LML” to the LM electrodes at Timing t9.

At Timing t11 to Timing t14, as same as Timing t4 to Timing t8, “HL” is imposed to the electrodes under which the signal electric charges are accumulated, and “HH” is sequentially imposed to the electrodes on the downstream. Then, the G signals and B signals read out to the HCCD 14 are sequentially transferred to downstream in the horizontal direction in order to be positioned on the downstream of the same colored signals in the vertical direction.

At Timing t15, “HH” is imposed to the H1, H2, H3 and H6 electrodes. At Timing t16, the entire signal electric charges remaining in the line memories 13 are read out to the HCCD 14 by imposing “LML” to the LM electrodes. At this time, the same colored signal electric charges as the signal electric charges to be read out are accumulated under the electrodes of the HCCD14 positioned on the downstream in the vertical direction. Therefore, the horizontal pixel addition is executed by this reading out.

Thereafter, at Timing t18 and Timing t19, the signal electric charges to which the horizontal pixel addition has been executed are transferred to the output amplifier in the horizontal direction.

Other than the above-described horizontal pixel addition by the eight-phase driving method of the HCCD 14, as shown in FIG. 13 or FIG. 14, the horizontal pixel addition can be executed by 6-phase driving method of the HCCD 14. In the timing chart shown in FIG. 13 or FIG. 14, imposing the same driving waveform to the H2 and H6 electrodes, or imposing the same waveform to the H4 and H8 electrodes realizes the horizontal pixel addition according to the six-phase driving method of the HCCD 14. Further, Patent Document: Japanese Laid-Open Patent 2002-185870 is referred as the prior art.

In the conventional solid-state imaging apparatus 10 as described in the above, it is necessary to drive the HCCD 14 with eight-phase or six-phase in order to execute the horizontal pixel addition. When all the pixels are read out without executing the horizontal pixel addition, the HCCD 14 can be driven with the two-phase driving method, and comparing to the two-phase driving method, those eight- or six-phase driving method requires three to four times of timing generating circuits for HCCD driving and amplifiers that are used as driving buffers; therefore, the horizontal addition according to the prior art may leads increase in a cost of the solid state imaging apparatus caused by increase in the number of the peripheral circuits or other parts and in a circuit area of the solid-state imaging apparatus. Moreover, a manufacturing cost may be increased by increase in the number of the terminals of the solid-state imaging apparatus and enlargement of the chip size caused by enlargement of a wiring area.

### SUMMARY OF THE INVENTION

It is an object of the present invention to provide a solid-state imaging apparatus that can realize a horizontal pixel addition by using a horizontal electric charge transfer device without increase in a cost.

According to one aspect of the present invention, there is provided a solid-state imaging apparatus, comprising: a semiconductor substrate that defines a two-dimensional surface; a plurality of photoelectric conversion elements, each of which generates a signal electric charge corresponding to an amount of incident light, the photoelectric conversion elements arranged in two-dimension on the semiconductor substrate; vertical signal charge transfer devices that are arranged between columns of the photoelectric conversion elements and transfer the signal electric charges generated by the photoelectric conversion elements in a vertical direction; a line memory that is arranged on ends of the vertical signal charge transfer devices and temporally stores the signal electric charges transferred by the vertical signal charge transfer devices; and a horizontal signal charge transfer devices that is consisted of four-phase electrodes, selectively reads the signal electric charges stored in the line memory, adds a plurality of the electric signal charges in a row direction and sequentially transfers the added electric signal charges.

According to the present invention, a solid-state imaging apparatus that can realize a horizontal pixel addition by using a horizontal electric charge transfer device without increase in a cost can be provided.

### BRIEF DESCRIPTION OF THE DRAWINGS

FIG. 1 is a plan view showing electrode structures of the HCCD 14 and a vicinity of the line memories 13 including the VCCD 12 of a solid state imaging apparatus according to the embodiment of the present invention.

FIG. 2 is a timing chart when the horizontal pixel addition is executed by driving the HCCD 14 with the four-phase driving method and a diagram showing movement of the signal electric charges according to the embodiment of the present invention.

FIG. 3 is a timing chart when the horizontal pixel addition is executed by driving the HCCD 14 with the four-phase driving method and a diagram showing movement of the signal electric charges according to a modified example of the embodiment of the present invention.

FIG. 4A is a schematic plan view showing a structure of a conventional solid state imaging apparatus 10. FIG. 4B is a block diagram showing structures of photoelectric conversion elements 11, VCCD 12, reading parts 3g and line memories 13.

FIG. 5 is a driving timing chart of the solid state imaging apparatus 10 at a time of reading all pixels.

FIG. 6A to FIG. 6G are diagrams for explaining movement of signal electric charges at Timing t1 to Timing t7 shown in FIG. 5.

FIG. 7 is a driving timing chart of the solid-state imaging apparatus 10 at a time of the horizontal pixel addition.

FIG. 8A to FIG. 8E are diagrams for explaining changes in the signal electric charges at Timing t1 to Timing t5 shown in FIG. 7.

FIG. 9 is a plan view showing electrode structures of the HCCD 14 and a vicinity of the line memories 13 including the VCCD 12.

FIG. 10 illustrates a schematic cross sectional view showing the structure of the part shown in FIG. 9. FIG. 10 also illustrates diagrams showing electric potential of the part shown therein.

FIG. 11 is a table representing a relationship between the electric potential and the movement of the signal electric charge.

FIG. 12 is a timing chart when the horizontal pixel addition is executed by the eight-phase driving method by the HCCD 14 and a diagram showing movement of the signal electric charges.

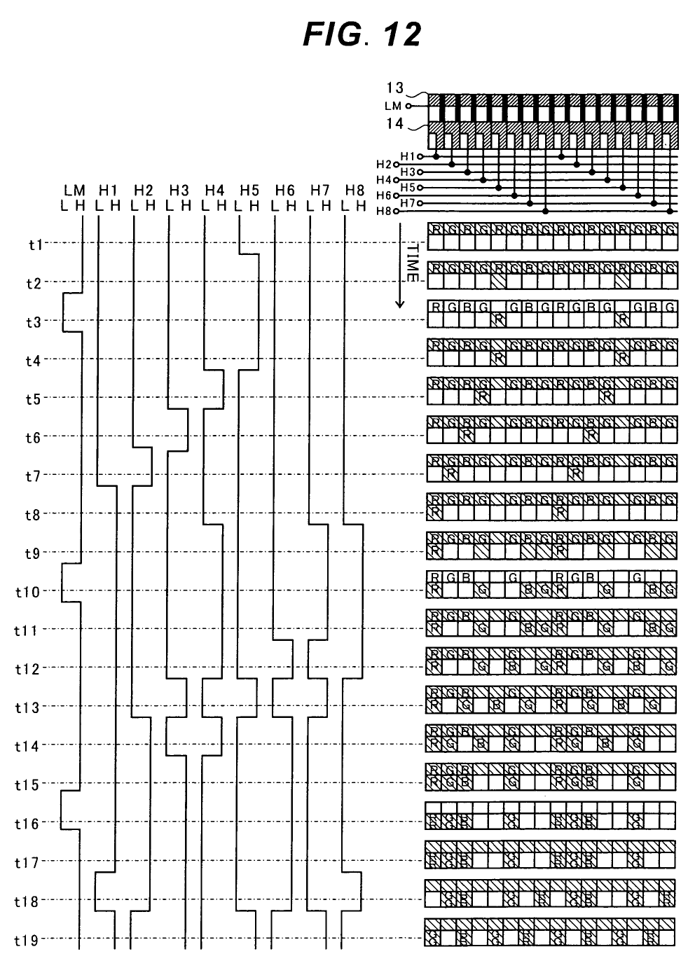

FIG. 13 is a first example of a timing chart when the horizontal pixel addition is executed by the six-phase driving method by the HCCD 14 and a diagram showing movement of the signal electric charges.

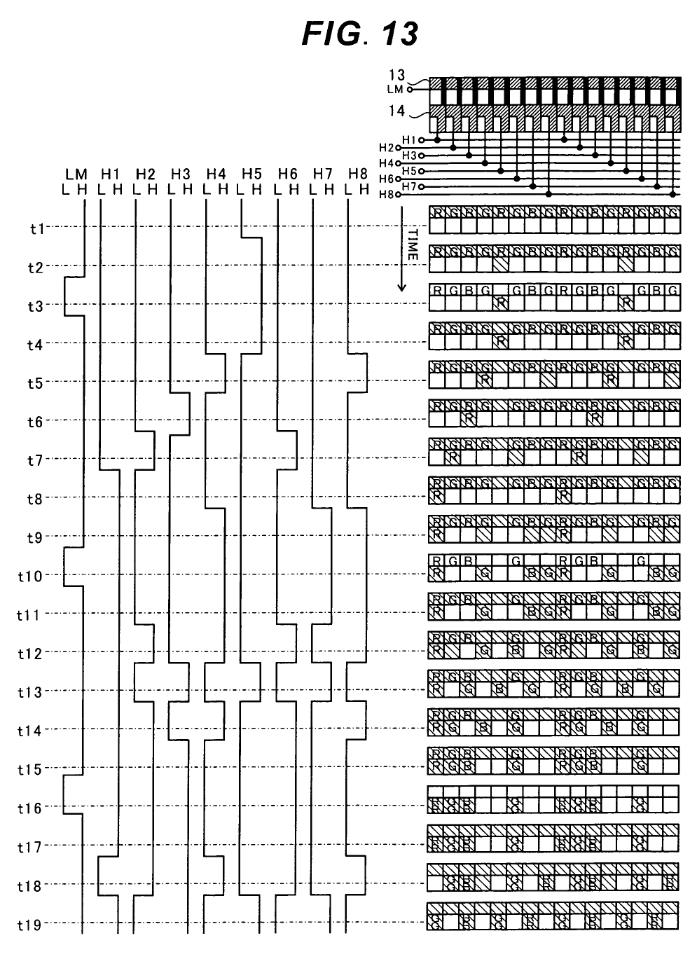

FIG. 14 is a second example of a timing chart when the horizontal pixel addition is executed by the six-phase driving method by the HCCD 14 and a diagram showing movement of the signal electric charges.

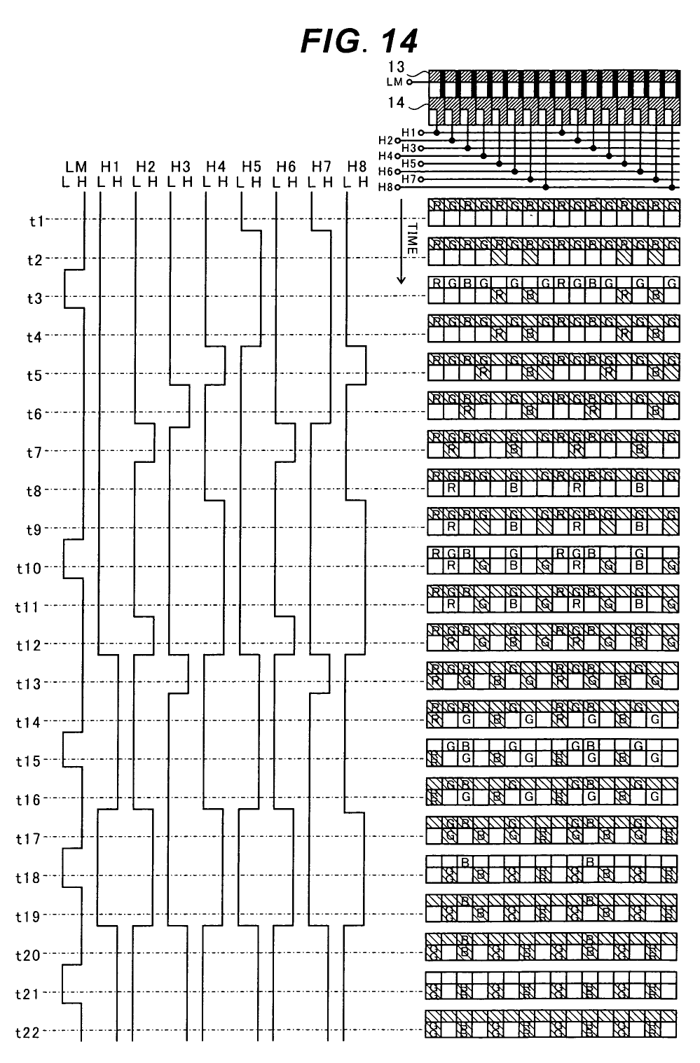

### DETAILED DESCRIPTION OF THE PREFERRED EMBODIMENTS

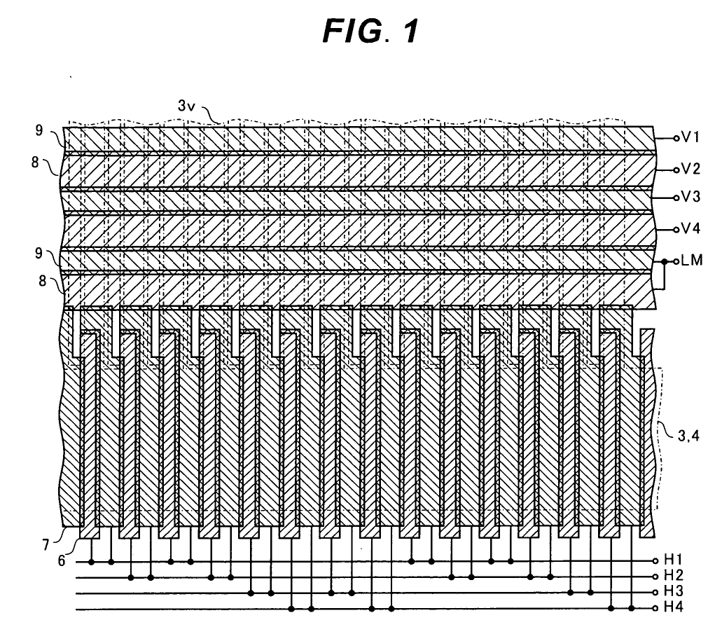

FIG. 1 is a plan view showing electrode structures of the HCCD 14 and a vicinity of the line memories 13 including the VCCD 12 of a solid state imaging apparatus according to the embodiment of the present invention. The structure of the solid state imaging apparatus according to the present invention is similar to that of the conventional solid state imaging apparatus other than that the number of driving phase for driving the HCCD 14 has been changed to 4-phase from 8-phase, and that the electrode structure has been changed. That is, the structures of the VCCD 12 and the line memories 13 are the same as the conventional solid state imaging device, and well-known technique can be used for the VCCD 12 and the line memories 13.

The HCCD 14 is driven by a four-phase (φH1 to φH4) driving technique for executing a horizontal pixel addition according to the embodiment of the present invention; however, the HCCD 14 can be driven by the conventional two-phase driving technique to transfer a signal electric charge when the horizontal pixel addition is not to be executed. An electrode 6 and an electrode 7 are electrically connected for one electrode for executing the well-known two-phase driving.

An electrode structure according to the embodiment of the present invention is characterized by repeating an electrode arrangement of “H1, H2, H1, H2, H3, H4, H3, H4” for every eight electrodes. By this electrode arrangement, the horizontal pixel addition is realized by the four-phase driving of the HCCD 14.

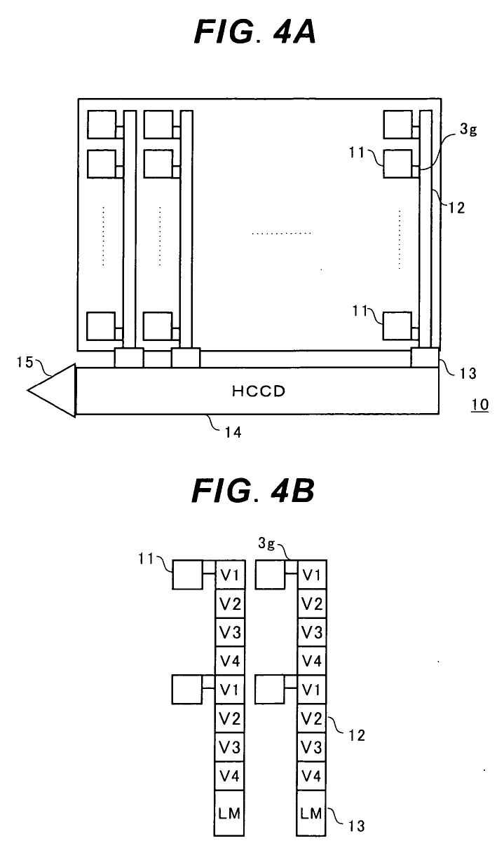

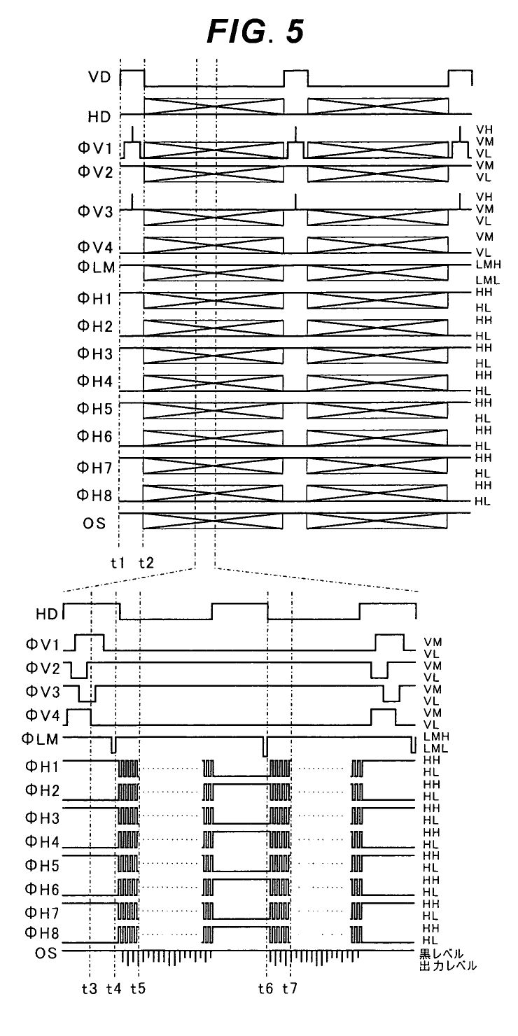

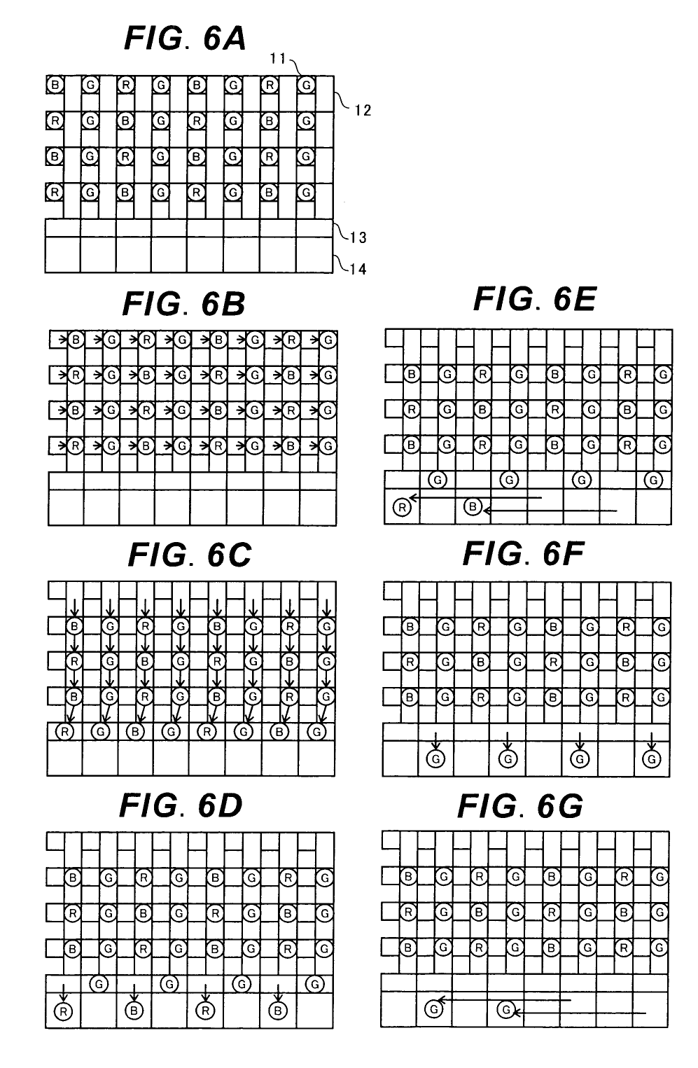

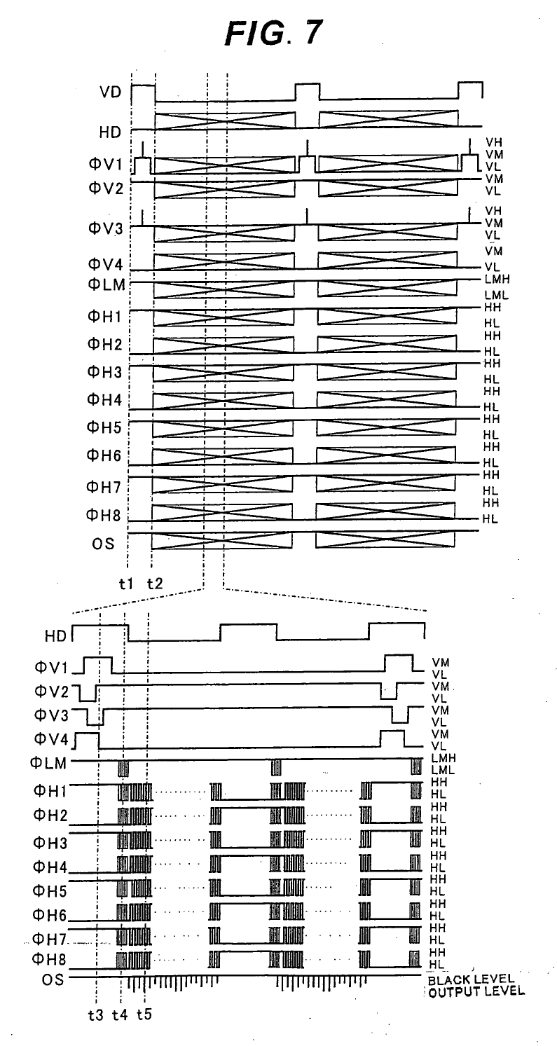

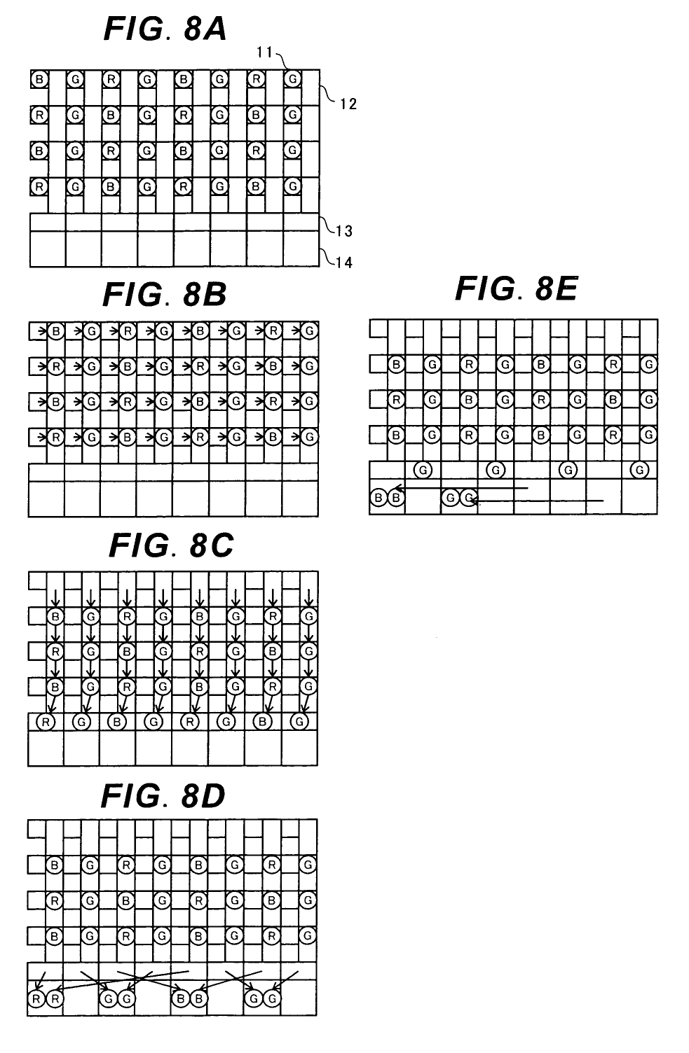

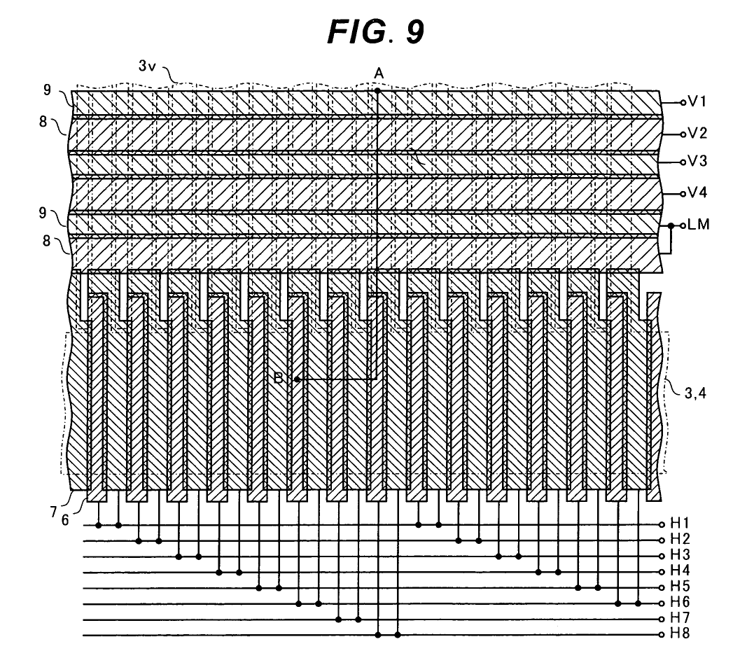

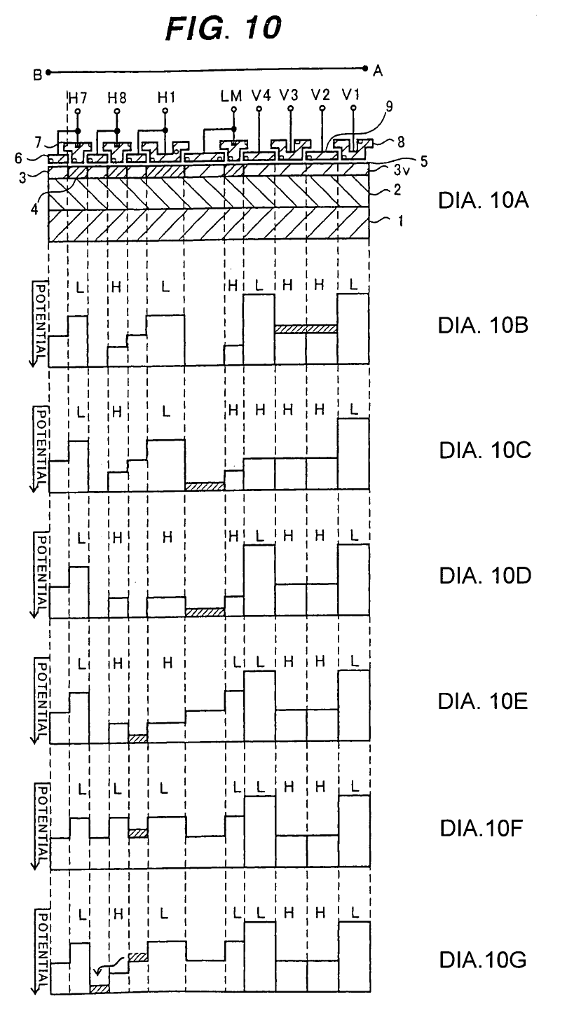

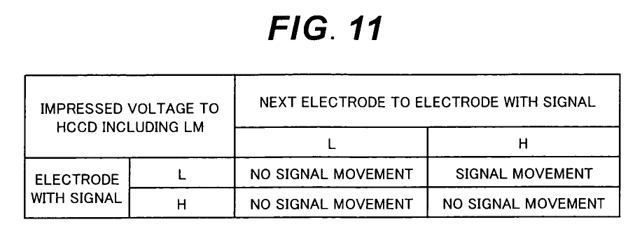

Moreover, other than the above-mentioned the number of phases for driving the HCCD 14, the electrode arrangement and the later-described timing of the driving waveform, structures described as the conventional technique with reference to FIG. 4A to FIG. 11 can be arbitrary adopted to the solid state imaging apparatus according to the embodiment. Therefore, the explanations for the parts similar to the conventional solid state imaging apparatus will be omitted.

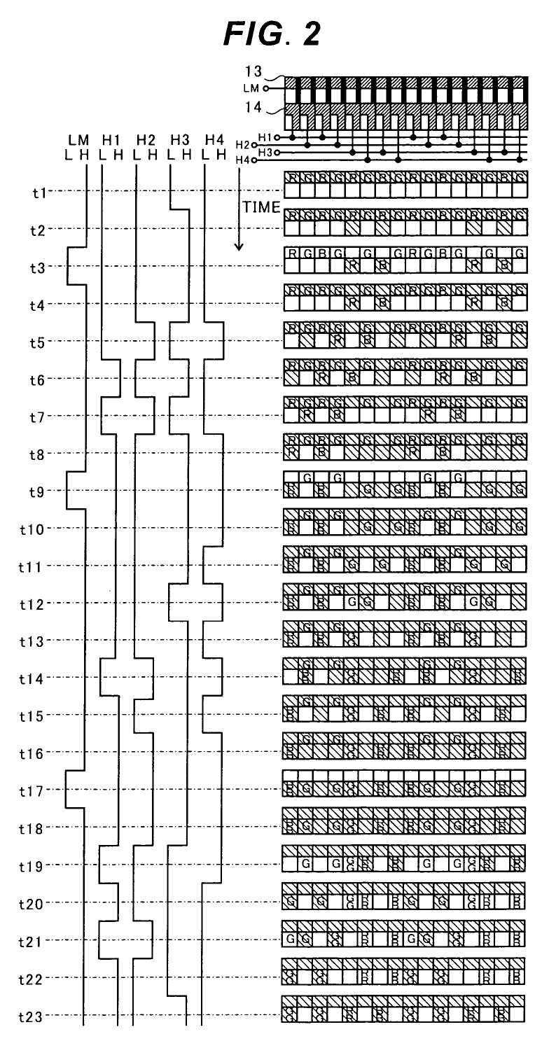

FIG. 2 is a timing chart when the horizontal pixel addition is executed by driving the HCCD 14 with the four-phase driving method and a diagram showing movement of the signal electric charges according to the embodiment of the present invention. In the drawings, the timing chart on the left side represents driving waveform of the line memory 13 and the HCCD 14, and a simple plan view on the right side represents the movement of the signal electric charges corresponding to the timing chart. In this plan view, an upper small square indicates the electrode (LM) of the line memory 13, and a lower large squire indicates the electrodes (H1 to H4) of the HCCD 14. Moreover, the parts marked with “R”, “G” and “B” indicate colors of the signal electric charges accumulated under each electrode, and the signal electric charges are accumulated where “R”, “G” and “B” are marked.

Timing t1 is a condition that the signal electric charges transferred from the VCCD 12 are accumulated in the line memories 13. After that, at Timing t2, “HH” is imposed to the H3 electrodes. Then at Timing t3, every one of two R signals and very one of two B signals in a horizontal direction are read out to the HCCD 14 by imposing “LML” on LM electrodes.

At Timing t4 to Timing t8, “HL” is imposed to the electrodes under which the signal electric charges are accumulated, and “HH” is sequentially imposed to the electrodes on the downstream. Then, the R signals and the B signals read out to the HCCD 14 are sequentially transferred to downstream in the horizontal direction to be positioned on the downstream of the same colored signals remaining in the line memories 13 in a vertical direction.

For example, at Timing t5, the signal charges under the H3 electrodes are moved to the H2 or H4 electrodes located one step on the downstream by imposing “HL” to the H3 electrodes while imposing “HH” to the H2 and H4 electrodes. Similarly, at Timing t6, the signal charges under the H2 and H4 electrodes are moved to the H1 and H3 electrodes one step on the downstream by imposing “HL” on the H2 and H4 electrodes while imposing “HH” on the H1 and H3 electrodes.

Moreover at by imposing “HH” to the H1, H3 and H4 electrodes Timing t8 and imposing “LML” on the LM electrodes at Timing t9, one of every two pairs of the G signals adjacent in horizontal direction are read out to the HCCD 14. Further, at the same time, the R signals and the B signals remaining in the line memories 13 are read out to the H1 electrodes of the HCCD 14. At this time, since the R signals and the B signals read out at Timing t3 have been moved to under the H1 electrodes at Timing t4 to Timing t8, the R signals and the B signals currently read out are added with the same colored signals read out at Timing t3.

Next, the G signals read out at Timing t8 are added in the HCCD 14 by an operation from Timing t10 to Timing t13. In detail, at Timing t11, the signal electric charges (two G signals) under the H4 electrodes are moved to under the H1 and H3 electrodes located one step on the downstream by imposing “HL” on the H4 electrodes while imposing “HH” on the H1 and H3 electrodes. At Timing t12, the signal electric charges (one of two G signals) in the H3 electrodes are moved to the H4 electrodes one step on the downstream by imposing “HL” on the H3 electrodes while imposing “HH” on the H4 electrodes. Moreover, at Timing t13, the signal electric charges (another one of two G signals) in the H4 electrodes are moved to the H3 electrodes one step on the downstream by imposing “HL” on the H4 electrodes while imposing “HH” on the H3 electrodes, and the two G signals read out at Timing t8 are added.

At Timing t14 and Timing t15, the R signals and the B signals added with the same colored signals in the HCCD 14 are transferred to downstream by two transfer steps.

At Timing t20, the G signals remaining in the line memories 13 are read out to the HCCD 14 by imposing “HH” on all the electrodes H1 to H4 at timing t16, and imposing “LML” on the LM electrodes at Timing t17. Then, the signal charges (two G signals) in the H2 electrodes are moved to under the H1 electrodes one step on the downstream by imposing “HL” on the H2 electrodes and imposing “HH” on the H1 electrodes. At Timing t21, the signal charges (one of the two G signals which is under the H1 electrode adjoining to the H2 electrode on the downstream) under the H1 electrodes are moved to one step on the downstream by imposing “HL” to the H2 electrodes and imposing “HH” to the H1 electrodes. Moreover, at Timing t22, the signal charges (another one of the two G signals) under the H2 electrodes are moved to under the H1 electrodes one step on the downstream by imposing “HL” to the H2 electrodes and imposing “HH” to the H1 electrodes, and the two G signals read out at Timing t17 are added.

Then, the signal electric charges added by the horizontal pixel addition are transferred in the horizontal direction after Timing t23.

As described in the above, the horizontal pixel addition can be executed by the four-phase driving of the HCCD 14.

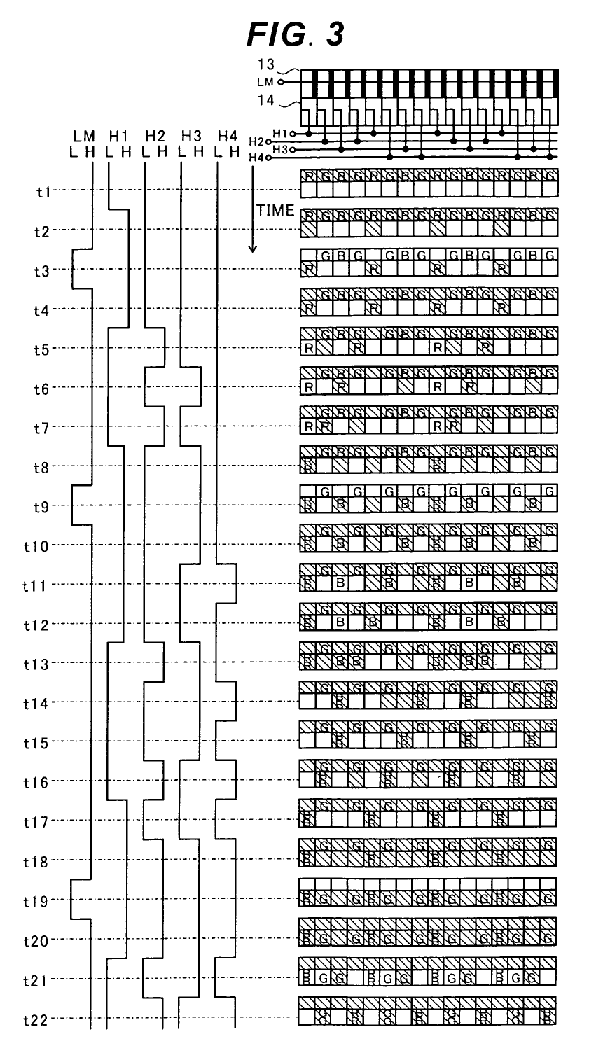

FIG. 3 is a timing chart when the horizontal pixel addition is executed by driving the HCCD 14 with the four-phase driving method and a diagram showing movement of the signal electric charges according to a modified example of the embodiment of the present invention. In the drawings, the timing chart on the left side represents driving waveform of the line memory 13 and the HCCD 14, and a simple plan view on the right side represents the movement of the signal electric charges corresponding to the timing chart. In this plan view, an upper small square indicates the electrode (LM) of the line memory 13, and a lower large squire indicates the electrodes (H1 to H4) of the HCCD 14. Moreover, the parts marked with “R”, “G” and “B” indicate colors of the signal electric charges accumulated under each electrode, and the signal electric charges are accumulated where “R”, “G” and “B” are marked.

In this modified example, an electrode arrangement of “H1, H2, H3, H2, H1, H4, H3, H4” is repeated at every eight electrodes as shown in FIG. 3.

At Timing t1 the signal electric charges transferred from the VCCD 12 are accumulated in the line memories 13. Thereafter, “HH” is imposed to the H5 electrodes at Timing t2, and “LML” is imposed to the LM electrodes at Timing t3, so that the R signals are read out to the HCCD 14.

At Timing t4 to Timing t8, the R signals read out at Timing t3 are added in the HCCD 14. In detail, the signal electric charges (one of two R signals) under the H1 electrodes (H1 which the down stream side is H2) are moved to under the H2 electrodes one step on the downstream by imposing “HL” to the H1 electrodes and imposing “HH” to the H2 electrodes. At Timing t6, the R signals under the H2 electrodes are moved to under the H3 electrodes one step on the downstream by imposing “HL” to the H3 electrodes and imposing “HH” to the H2 electrodes. Moreover, at Timing t7, the R signals under the H3 electrodes are moved to under the H2 electrodes one step on the downstream by imposing “HL” to the H3 electrodes and imposing “HH” to the H2 electrodes. Then, at Timing t8, the two adjacent R signals read out under the H1 electrodes are added by imposing “HL” to the H2 electrodes and imposing “HH” to the H1 electrodes.

At Timing t8, “HH” is further imposed to the H3 electrodes, and “LML” is imposed to the LM electrodes at Timing t9. Then, the B signals are read out to the HCCD 14.

At Timing t9 to Timing t14, the B signals read out at Timing t9 are added in the HCCD 14. In detail, at Timing t11, the signal electric charges (one of two B signals) in the H3 electrodes (H3 on which the downstream is H4) are moved to the H4 electrodes one step on the downstream by imposing “HL” to the H3 electrodes and imposing “HH” to the H4 electrodes. At Timing t12, the B signals under the H4 electrodes are moved to under the H1 electrodes one step on the downstream by imposing “HL” to the H4 electrodes and imposing “HH” to the H1 electrodes. Moreover, at Timing t13, the B signals under the H1 electrodes are moved to under the H2 electrodes one step on the downstream by imposing “HL” to the H1 electrodes and imposing “HH” to the H2 electrodes. Then, at Timing t14, the two adjacent B signals read out under the H3 electrodes are added by imposing “HL” to the H2 electrodes and imposing “HH” to the H3 electrodes.

At Timing t15, the added R signals under the H4 electrodes are moved to under the H3 electrodes one step on the downstream by imposing “HL” to the H4 electrodes and imposing “HH” to the H3 electrodes. At Timing t16, the added R signals and the added B signals in the HCCD 14 are transferred one transfer step on the downstream by imposing “HL” to the H1 and H3 electrodes and imposing “HH” to the H2 and H4 electrodes. At Timing t17, the added R signals and the added B signals in the HCCD 14 are transferred further one transfer step on the downstream by imposing “HL” to the H2, H3 and H4 electrodes and imposing “HH” to the H1 electrodes.

The G signals remaining in the line memories 13 are read out to the HCCD 14 by imposing “HH” to all the electrodes H1 to H4 at timing t18 and imposing “LML” on the LM electrodes at Timing t19. Then, the signal charges (one of the two G signals) under the H2 and H4 electrodes are moved to under the H3 electrodes one step on the downstream by imposing “HL” to the H1, H2 and H4 electrodes and imposing “HH” to the H3 electrodes. At Timing t22, the signal charges (another one of the two G signals) under the H3 electrodes are moved to under the H2 or H4 electrode one step on the downstream by imposing “HL” to the H1 and H3 electrodes and imposing “HH” to H2 and H4 electrodes. Then, the two G signals read out at Timing t19 are added under the H2 or H4 electrode. The transferring operations after the above are the same as the embodiment shown in FIG. 2.

As described in the above, according to the embodiments and modified example of the present invention, although the number of the driving phases of the HCCD decreases to four-phase, the horizontal pixel addition can be executed. Therefore, the horizontal pixel addition becomes possible without increasing in a cost followed by increase in the peripheral circuit, the number of the parts and the circuit area of the solid-state imaging apparatus.

The present invention has been described in connection with the preferred embodiments. The invention is not limited only to the above embodiments. It is apparent that various modifications, improvements, combinations, and the like can be made by those skilled in the art.

What are claimed are:

1. A solid-state imaging apparatus, comprising:
a semiconductor substrate that defines a two-dimensional surface;
a plurality of photoelectric conversion elements, each of which generates a signal electric charge corresponding to an amount of incident light, the photoelectric conversion elements arranged in two-dimension on the semiconductor substrate;
vertical signal charge transfer devices that are arranged between columns of the photoelectric conversion elements and transfer the signal electric charges generated by the photoelectric conversion elements in a vertical direction;
a line memory that is arranged on ends of the vertical signal charge transfer devices and temporally stores the signal electric charges transferred by the vertical signal charge transfer devices; and
a horizontal signal charge transfer devices that is consisted of four-phase electrodes, selectively reads the signal electric charges stored in the line memory, adds a plurality of the electric signal charges in a row direction and sequentially transfers the added electric signal charges.

2. A driving method for a solid-state imaging apparatus, comprising a semiconductor substrate that defines a two-dimensional surface; a plurality of photoelectric conversion elements, each of which generates a signal electric charge corresponding to an amount of incident light, the photoelectric conversion elements arranged in two-dimension on the semiconductor substrate; vertical signal charge transfer devices that are arranged between columns of the photoelectric conversion elements and transfer the signal electric charges generated by the photoelectric conversion elements in a vertical direction; a line memory that is arranged on ends of the vertical signal charge transfer devices and temporally stores the signal electric charges transferred by the vertical signal charge transfer devices; and a horizontal signal charge transfer devices that reads the signal electric charges stored in the line memory, adds a plurality of the electric signal charges in a row direction and sequentially transfers the added electric signal charges, wherein
the method is characterized by that the horizontal signal charge transfer devices is driven by a four-phase driving method.
